(19) United States
(12) Patent Application Publication
(10) Pub. No.: US 2007/0292832 A1
(43) Pub. Date: Dec. 20, 2007

(54) System for visual creation of music

(75) Inventors: Michael D. Doyle, Wheaton, IL (US); Maurice J. Pescitelli, Wheaton, IL (US); Cynthia M. Lilagan, River Forest, IL (US)

Correspondence Address: Trellis Intellectual Property Law Group, PC, 1900 EMBARCADERO ROAD, SUITE 109, PALO ALTO, CA, 94303, US

(73) Assignee: Eolas Technologies Inc., Wheaton, IL (US)

(21) Appl. No.: 11/444,867

(22) Filed: May 31, 2006

(51) Int. Cl. G09B 5/00

(52) U.S. Cl. 434/308

(57) ABSTRACT

A system for creating sound using visual images. Various controls and features are provided for the selection, editing, and arrangement of the visual images and tones used to create a sound presentation. Visual image characteristics such as shape, speed of movement, direction of movement, quantity, location, etc. can be set by a user. Tone characteristics such as notes, chords, musical instrument styles, tempo, etc. can also be set by the user. In a preferred embodiment, the sound presentation can be saved to a file for playback at a later time or linked to a visual image in a sound presentation.

### COMPUTER PROGRAM LISTING APPENDIX

A computer program listing appendix is provided on one CD-ROM with this application. The information on the CD-ROM is hereby incorporated by reference as if set forth in full in this application for all purposes. The CD-ROM is provided in duplicate. Details of the contents of the CD-ROM are provided starting at paragraph 71 which references a list of the files on the CD-ROM included in Table I, below. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text, otherwise all copyright rights are reserved.

### BACKGROUND OF THE INVENTION

The present invention relates generally to the electronic generation of sound and, more specifically, to a system that allows a user to author presentations of sound, such as music etc. using visual images.

Today, digital processing systems such as computers are used in many applications including business, education and entertainment. Some applications allow human users to create entertainment, educational or artistic works such as music compositions. However, these applications or programs often require music theory knowledge or the ability to play an instrument in order for a composition to be entered or captured into a format that can be played back. The composition process can be daunting for a person who is not trained as a musician or who is not familiar with music theory and notation. Even trained musicians may be encumbered by programs for creating or composing music because the program's user interface that dictates how the composition must be entered is foreign to the musician. The musician may have to spend a long time learning the program and may have to develop a new set of skills in order to become efficient with the program.

Traditional programs can also interfere with the creative musical process, itself. Often, a program may require the memorization of command names, keystrokes, hotkeys, menu item locations, parameter values, etc. A composer may be forced to consider mathematics, logical relationships, audio mechanics or other “left brain” functions while trying to achieve “right brain” functions that may be useful in composing. Thus, the program might actually be a block to capturing an artistic expression. Programs with inefficient or unappealing user interfaces are not able to inspire or direct a user's efforts to achieve a desirable composition simply and intuitively.

### SUMMARY OF THE INVENTION

Embodiments of the present invention allow a user to author a visual presentation of sound using visual images. In a preferred embodiment of the present invention, the presentation of sound is created using a graphical object displayed on a canvas of a display screen and a tracking object moving within the canvas of the display screen such that when the tracking object is in a predetermined relationship with the graphical object a tone is sounded. The user can control the presentation of sound by setting the shape, color, arrangement, quantity, etc. of the graphical objects; by setting the movement, quantity, etc. of the tracking objects; by disabling regions of the display screen canvas; by selecting tones, tone volume, etc.

A user can control the presentation of sound by setting the shape, color, arrangement, quantity, and other characteristics of the graphical objects; by setting the movement, quantity, etc. of the tracking objects; by disabling regions of the display screen canvas; by selecting tones, tone volume; or by performing other operations.

The presentation can be saved to a file for playback at a later time or for linking to a graphical object so that when the linked graphical object is in predetermined relationship with a tracking object, the presentation is played.

In an added embodiment of the invention, a user can play music directly from a PC keyboard.

### BRIEF DESCRIPTION OF THE DRAWINGS

FIG. 1 illustrates the basic approach of the invention.

FIG. 2 is a first screen display to illustrate the operation of the invention;

FIG. 3 is a next screen display to illustrate the operation of the invention;

FIG. 4 is a next screen display to illustrate the operation of the invention;

FIG. 5 is a next screen display to illustrate the operation of the invention;

FIG. 6 is a next screen display to illustrate the operation of the invention;

FIG. 7 is a next screen display to illustrate the operation of the invention;

FIG. 8 is a next screen display to illustrate the operation of the invention;

FIG. 9 is a next screen display to illustrate the operation of the invention;

FIG. 10 is a next screen display to illustrate the operation of the invention;

FIG. 11 is a next screen display to illustrate the operation of the invention;

FIG. 12 is a next screen display to illustrate the operation of the invention;

FIG. 13 is a next screen display to illustrate the operation of the invention;

FIG. 13A is an illustration of computer system suitable for use with the present invention;

FIG. 13B shows subsystems in the computer system of FIG. 13A; and

FIG. 13C is a generalized diagram of a typical network.

### DETAILED DESCRIPTION OF THE INVENTION

Preferred embodiments of the present invention are included in the music authoring program called “Muse 1.0,” manufactured by Eolas Technologies Inc. The source code for Muse 1.0 is provided with this application in the source code Appendix. The Appendix should be consulted for details about a preferred embodiment of the invention. The Muse 1.0 program uses Tcl/Tk code and Tcl Starkit technology.

Additionally, a hardcopy appendix has been included that describes the application programming interface (API) for the Muse 1.0 product.

The present invention is presented below and is discussed in connection with a preferred embodiment and with the Figures. First, an overview of the invention and a preferred embodiment are presented. Next, features of the Muse 1.0 program are discussed. Finally, the standard hardware appropriate for use with the present invention is described.

### Overview of the Invention

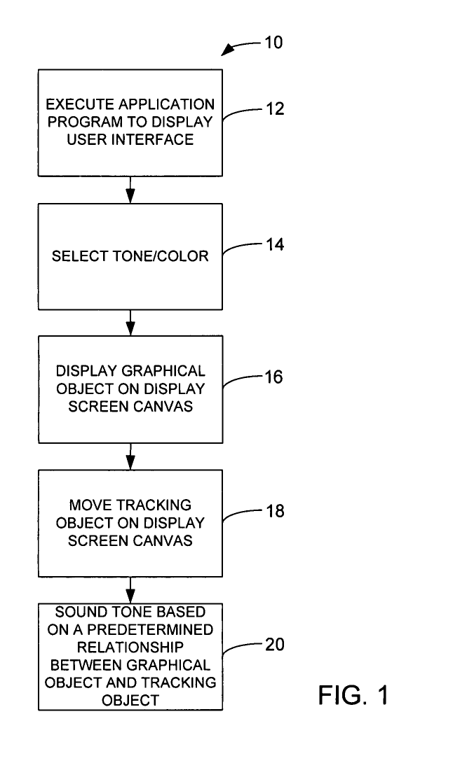

FIG. 1 illustrates a basic approach of the invention.

In FIG. 1, a preferred embodiment provides an authoring program, Muse 1.0 that allows a user to create sound by using images and movement. The user creates a visual representation by defining graphical objects on a canvas of a display screen. Tracking objects move across the canvas and interact with the graphical objects so that selected tones are sounded in patterns or sequences to form a composition of sound when a tracking object is in a predetermined relationship with a graphical object. The user can further manipulate the visual presentation of sound by setting the quantity, speed, direction, path or behavior of tracking objects; moving tracking and graphical objects to desired positions on the display screen canvas; disabling regions of the display screen canvas; selecting a musical instrument style for a tone; setting the volume of the sound; drawing graphical objects that are visible, but do not play sounds; linking musical artwork files to an object, etc.; and other features explained in detail below.

Once the user finalizes the visual presentation of sound, the user can simply view the presentation or save the presentation in a musical artwork file to facilitate playback at a later time, to link the musical artwork file to an object in the presentation, to share compositions with other users, etc. A user can also save the audio playback to a file, use the resulting audio and/or image data as input to other programs or functions, import items such as predefined objects, images or video, that can act as objects or paths within the presentation or can import other presentation characteristics; play music directly from a PC keyboard, and perform other functions.

### Creation of a Visual Presentation of Sound

A first step in creating music or any other sound composition by using electronically generated visual images is to display one or more graphical objects on the canvas of a display screen using drawing tools. Alternatively, a user can display graphical objects on the display screen canvas by importing existing graphical objects. Graphical objects in the present invention can include any electronic visual image including photographic images, graphical images, video images, etc. that are either drawn directly onto the display screen canvas or imported and displayed on display screen canvas.

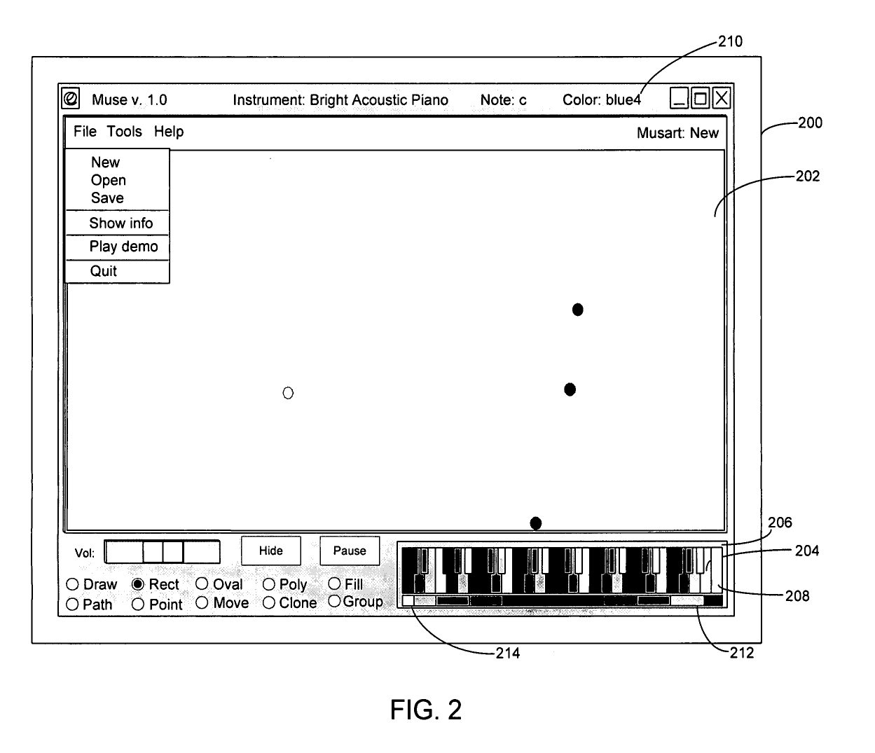

FIG. 2 shows a dialog box 3 used in Muse 1.0 that allows a user to draw a graphical object on a display screen canvas 5. To clear the display screen canvas 5, the user selects the “File” button from the dialog box toolbar and selects “New” option from the drop-down menu.

In a preferred embodiment of the present invention, a graphical object can have a tone characteristic and a color characteristic. As shown in FIG. 2, the user selects the tone and the color by moving a cursor over color-coded note keys 7 of an onscreen keyboard 9 and, using a left mouse click, selecting a note key 11. When the note key 11 is selected, the user will hear a musical note (e.g. C, C#, D, D#, etc.) associated with the key selected and the name of the note will be displayed in the title bar 13 at the top of the Muse 1.0 dialog box 3. Alternatively, the user can select a tone and a color by moving the cursor over color-coded chord keys 15 of the onscreen keyboard 9 and selecting a chord key 17 with a left mouse click. When the chord key 17 is selected, the user will hear a musical chord (e.g. Cmajor, Dminor, Eminor, etc.) associated with the key selected and the name of the chord will be displayed in the title bar at the top of the Muse 1.0 dialog box 3.

To modify the tone or color characteristic of a graphical object, the user can select the “Fill” button at the bottom of the dialog box; select a new tone and color from the onscreen keyboard using the steps discussed above, and left-click the mouse on the graphical object to change the tone and color of the graphical object.

It is important to note that in the present invention the characteristics of a graphical object can be any visual or audio characteristic or none at all. For example, as shown in FIG. 2, to draw a graphical object on the display screen canvas that does not have a tone characteristic, the user can select the leftmost chord key 19 (a key color-coded in white in the Muse 1.0 product) from the onscreen keyboard 9 and draw a graphical object using the steps discussed below. This feature allows a user to draw a graphical object that is visible, but that does not sound a tone when the predetermined relationship between the graphical object and a tracking object is triggered.

It is also important to note that the present invention does not limit a tone to a musical note or a musical chord. Rather, a tone can include any audible sound such as a bell, a siren, a voice, etc. Finally, in the present invention, the user's method for the selection of tones and colors etc. is not limited to an onscreen keyboard, but can be accomplished using PC keyboards, touch pads, data files, etc.

As shown in FIG. 2, after the tone and the color have been selected, the user can draw the graphical object on the canvas 5 of the display screen by first selecting the type of graphical object to be drawn. In a preferred embodiment, the user can select from graphical object types that include lines, rectangles, ovals, polygons, etc. A line is selected by left mouse clicking the “Draw” button at the bottom of the dialog box. In a preferred embodiment, the user can also set the width of the line by selecting the “Tools” button on the toolbar, selecting the “Configure” menu option, and selecting the “Set Line Width” menu option which causes a list of width settings to be displayed, and finally selecting a width from the list of settings. A rectangle is selected by left mouse clicking the “Rectangle” button, an oval is selected by left mouse clicking the “Oval” button and a polygon is selected by left mouse clicking the “Poly” button. It is important to note that the present invention is not limited to a particular type of graphical object and can include any type of graphical object including circles, triangles, photographic images, video images, etc.

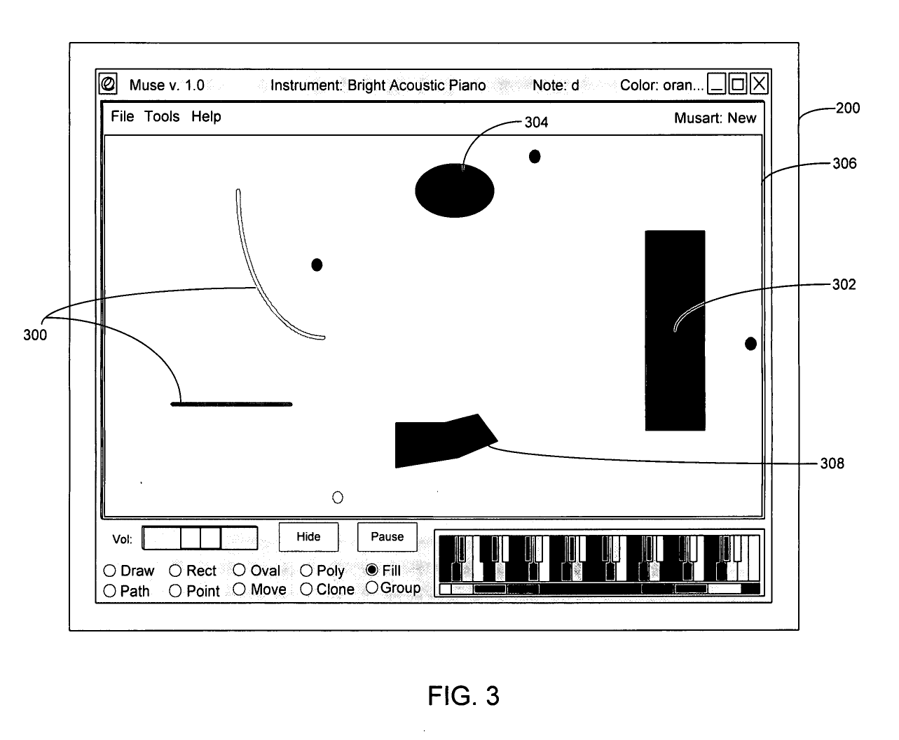

Next, as shown in FIG. 3, the user can draw a line 21, a rectangle 23 or an oval 25 by moving the cursor to a desired position on the display screen canvas 5, left-clicking the mouse at the desired cursor position and dragging the mouse to create an image of the graphical object. The user can draw a polygon 27 by moving the cursor to a desired starting position on the display screen canvas 5, left-clicking the mouse at a starting cursor position, and then left-clicking the mouse at intermediate cursor positions on the display screen canvas 5 to form an outline of the polygon 27.

After a graphical object is displayed on the display screen canvas, the user can move the graphical object to a new position on the canvas by selecting the “Move” button at the bottom of the dialog box 3 of FIG. 2, left-clicking the mouse on the graphical object and, while holding the left mouse button, dragging the graphical to a desired position on the display screen canvas.

In a preferred embodiment, one or more graphical objects can be drawn on the display screen canvas. A new graphical object can be drawn each time using the steps outlined above. Alternatively, the user can duplicate a graphical object that has already been displayed, by selecting the “Clone” button on the dialog box toolbar, left-clicking the mouse on the graphical object and holding the left mouse button down while using the mouse to drag a copy of the graphical object to a desired position on the display screen canvas.

Multiple graphical objects can also be grouped together as a single unit and duplicated or moved by selecting the “Group” button on the Muse 1.0 dialog box toolbar (the “Group” button changes to an “End Grp” button), using the mouse to place a band around the graphical objects being grouped and then selecting either the “Clone” button to duplicate the grouped graphical objects or the “Move” button to move the grouped graphical objects. Once the user is finished moving or duplicating the grouped objects, the user can ungroup the objects by selecting the “End Grp” button.

To delete a graphical object, the user right-clicks the mouse on the graphical object which causes a popup menu to appear. The user selects the “Delete” option from the popup menu. After selecting the “Delete” option, a confirmation popup dialog box appears. Selecting the “Yes” button from the confirmation popup dialog box deletes the graphical object and selecting the “No” button cancels the deletion request.

A next step in creating sound by using electronically generated visual images is to move a tracking object within the display screen canvas so that when the tracking object is in a predetermined relationship with a graphical object a tone sounds. The present invention is not limited to a particular predetermined relationship between the graphical object and the tracking object. For example, the tone can be sounded when the tracking object is in proximity to the graphical object, within the graphical object, at a point of impact with the graphical object or when impact with the graphical object is ended, at an entry boundary of the graphical object or at an exit boundary of the graphical object, etc. Additionally, the criterion for triggering the sounding of the tone can change dynamically over time (during execution) or can be different for different graphical objects, etc. In a preferred embodiment, the graphical object is highlighted when the tone sounds.

In a preferred embodiment of the invention, there a two categories of tracking objects, default tracking objects and user-defined tracking objects. In both categories, the tracking object moves along a path on the display screen canvas and a tone is sounded when the tracking object is in a predetermined relationship with a graphical object.

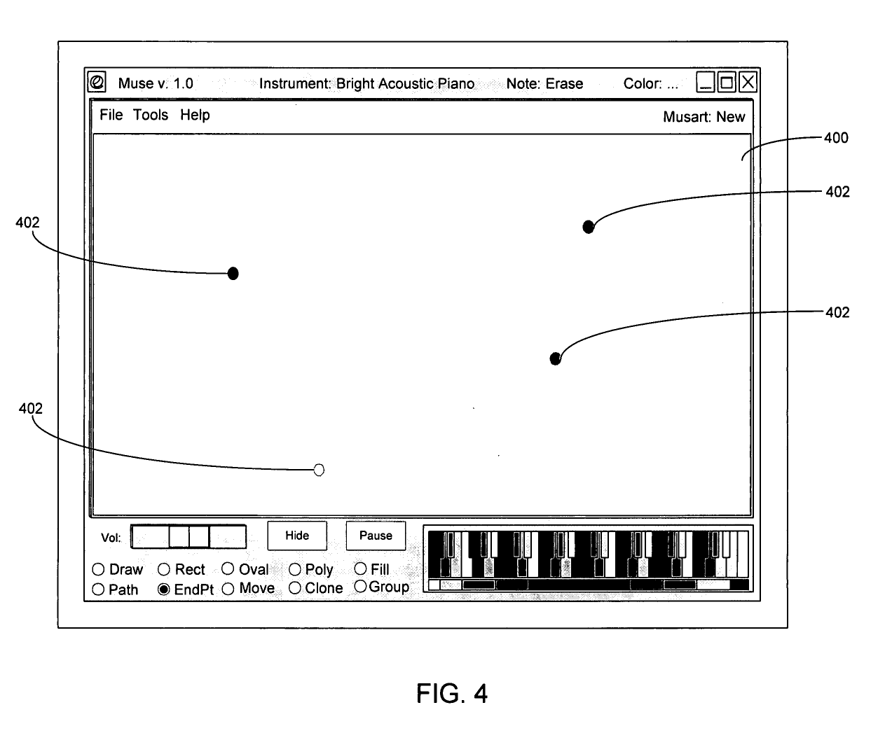

FIG. 4 shows a display screen canvas containing default tracking objects.

Each of the default tracking objects moves across the display screen canvas along a path in a default direction and speed. The values for direction, speed and other object properties can be programmed by the software manufacturer. The user can be allowed to change the default settings. One way to allow user specification of object properties is via menu or control selections. Another approach is to provide an editable properties file that is read by the program upon startup, creation of a new canvas, or some other event.

The user can disable the default tracking objects by either selecting the “Tools” button from the dialog box toolbar and selecting the “Hide Default Trackers” option from the drop-down menu or by pressing the “F2” function key on a PC keyboard. To enable the default tracking objects the user can select the “Tools” button from the dialog box toolbar and select the “Show Default Trackers” option from the drop-down menu or press the “F2” function key again on a PC keyboard. When the presentation is saved by steps discussed in detail below, the state of the default tracking objects (either enabled or disabled) is also saved.

In a preferred embodiment, the Muse 1.0 system provides two features that allow a user to create a user-defined tracking object and to set the movement of the tracking object on the display screen canvas. The two features are herein further referenced as the “path feature” and the “point feature.” Both features allow a user to set the movement of a tracking object along a path on the display screen canvas based on direction, speed, etc.

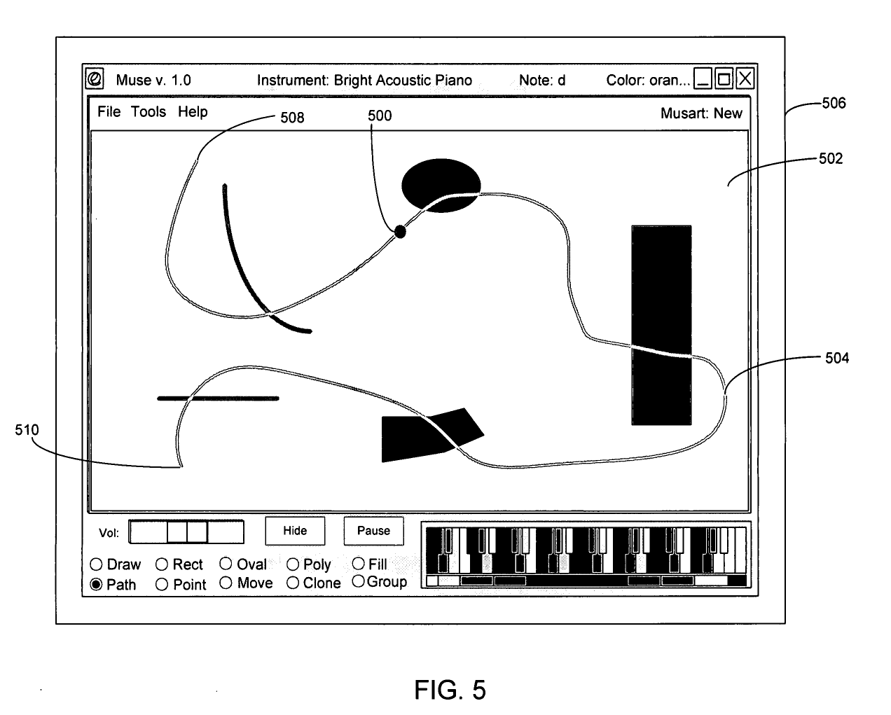

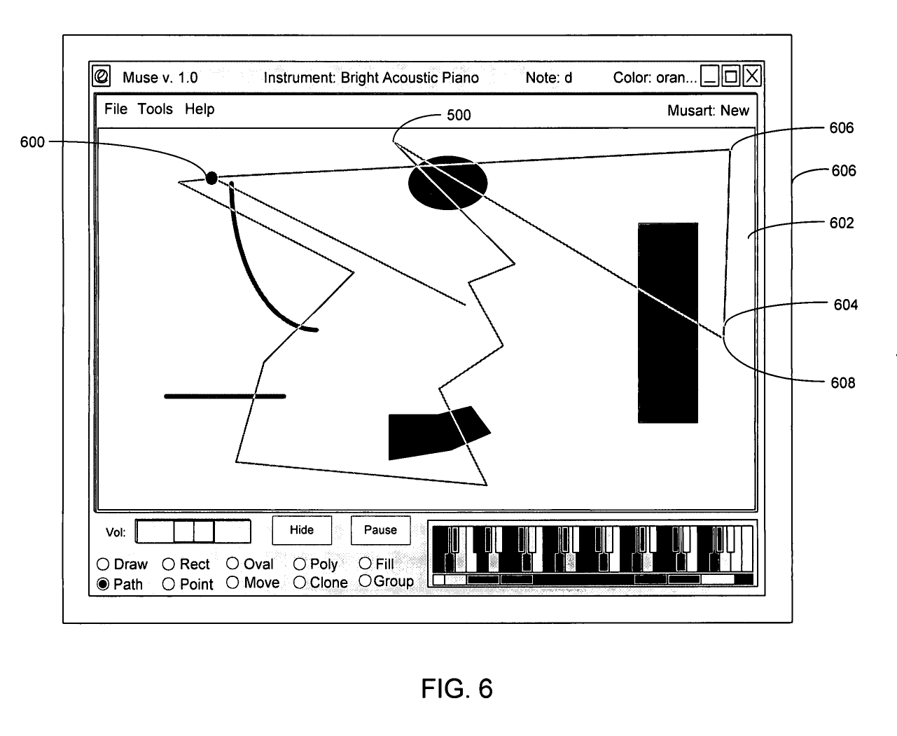

FIGS. 5 and 6 show a display screen containing user-defined tracking objects.

FIG. 5 shows a user-defined tracking object 35 whose movement on a display screen canvas 5 is set using the path feature.

The path feature, allows the user to create a tracking object path by first selecting the “Path” button from bottom of the Muse 1.0 dialog box of FIG. 2. Next, as shown in FIG. 5, the user can set the direction of the tracking object path by placing the cursor on the display screen canvas 5 at a starting cursor position 31 and by dragging the mouse moving the cursor over the display screen canvas 5, in any direction, to a desired ending cursor position 33. In a preferred embodiment, the tracking object will move along a path 33 from the starting cursor position 31 towards the ending cursor position 33 and when the tracking object 35 reaches the end of the path at the ending cursor position 33, the tracking object 35 repeats its movement along the path 33 beginning at the starting cursor position 31.

In a preferred embodiment, the user can make the user-defined path visible while it is being drawn or after it has been drawn, by first selecting the “Tools” button from the Muse 1.0 dialog box toolbar and then selecting the “Show Paths” menu option or by pressing the “F1” function key on a PC keyboard. To hide the path, the user can select the “Tools” button from the dialog box toolbar and then select the “Hide Paths” menu option or the user can press the “F1” function key on the PC keyboard again.

Using the path feature, the speed of a tracking object is initially set according to the speed at which the mouse is dragged along the display screen canvas when the path is being drawn. In other words, the faster the mouse is dragged while drawing the path, the faster the tracking object will move along the path during playback. So to produce, for example, a rapid or repeating pattern of sound, the path can be drawn with quick or short movements of the mouse. To produce a varied pattern of sound, the path can be drawn with varied quick or short mouse movements in combination with slow or long mouse movements.

The speed of individual tracking objects can also be set by right mouse clicking on the tracking object itself or by right mouse clicking on the path of the tracking object. Right clicking on the tracking object or tracking object path causes a popup menu to display. By selecting the “Tracker Speed” popup menu option, a list of tracking object speeds is displayed for the user to select from. To make right-clicking the tracking object easier, the user can stop the movement of the tracking object by selecting the “Pause” button on the Muse 1.0 dialog box toolbar before right-clicking the mouse on the tracking object. To make selecting the tracking object path easier, the user can first make the path visible by selecting the “Tools” button on the Muse 1.0 dialog box toolbar and then selecting the “Show Paths” menu option or by pressing the “° F. 1” function key on a PC keyboard.

FIG. 6 shows a user-defined tracking object 41 whose movement on a display screen canvas 5 is set using the point feature.

The point feature, allows the user to define the path of a tracking object by selecting the “Point” button on the dialog box toolbar of FIG. 2. As shown in FIG. 6, after selecting the “Point” button, the user places the cursor on the display screen canvas 5 and left-clicks the mouse at discrete cursor positions 43 that the user would like the tracking object 41 to move to in sequence. When the user is finished selecting the sequence of cursor positions 43, the “End Pt” button can be selected from the dialog box toolbar of FIG. 2 and the sequence of selected cursor positions 43 will define a path 45 over which the tracking object 41 will repeatedly move.

To set the speed at which the tracking object 41 moves along the path 45 using the point feature, the user can left-click the mouse several times at a particular cursor position before selecting a new cursor position which causes the tracking object 41 to pause at that position. Similar to the tracking objects created using the path feature, the speed of a tracking object can also be set from a list tracking object speeds by right mouse clicking on the tracking object itself or by right mouse clicking on the path of the tracking object.

### Other Features

In view of the discussion above, it should be apparent that the Muse 1.0 interface provides many controls and features that allow a user to easily author a visual presentation of sound. Further, as discussed below, the Muse 1.0 interface provides additional controls and features that allow a user to create more sophisticated visual sound presentations.

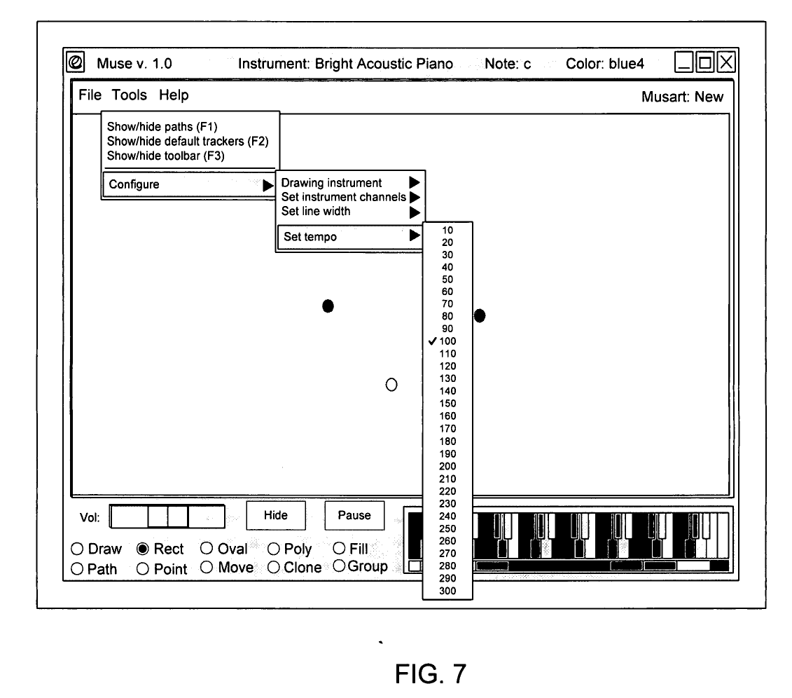

FIG. 7 shows a feature of a preferred embodiment of the present invention that allows a user to set the tempo at which a tracking object moves on the display screen canvas. In a preferred embodiment, the tempo of a tracking object is a rate of speed over a distance. For example, the tempo can be represented by the number of times per minute that a tracking object moves along the entire distance of a path. Any other suitable criteria can be used to define a tempo, such as a simple rate (e.g., inches, centimeters, pixels, etc.; per second). To set the tempo of a tracking object the user can select the “Tools” button on the dialog box tool bar, select the “Configure” menu option, next select the “Set Tempo” menu option which causes a list of tempo settings to display, and finally select a tempo setting from the list.

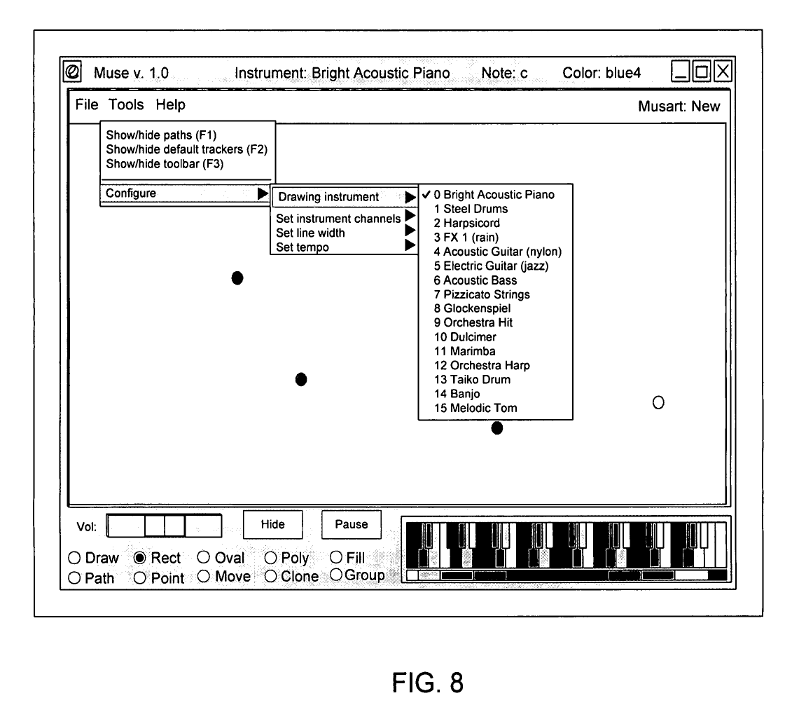

In FIG. 8, a further feature of a preferred embodiment allows a user the option to sound a tone using a musical instrument style. The user can chose from a group of sixteen different musical instrument sound styles by selecting the “Tools” button from the dialog box toolbar, selecting the “Configure” option from the drop-down menu, then selecting the “Drawing Instrument” menu option, and finally selecting an instrument style from the list shown.

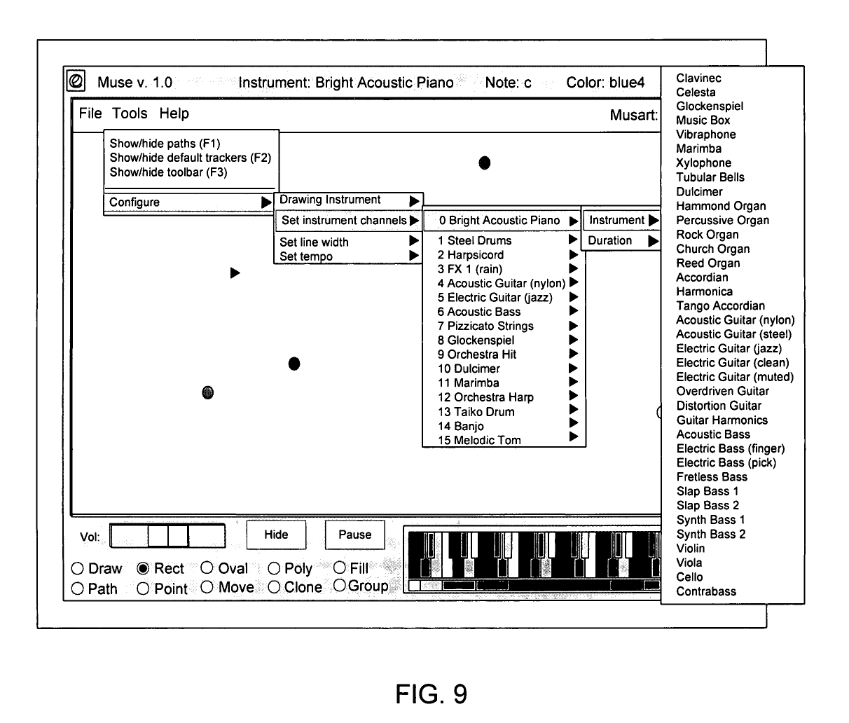

As shown in FIG. 9, the user can also select from a larger group of one-hundred-twenty-eight different musical instrument styles. In this feature, each of the sixteen instruments sound styles discussed above corresponds to one of sixteen reconfigurable channels thereby creating a total of one-hundred-twenty-eight different musical instrument styles. To set an instrument style using this feature, the user selects the “Tools” button from the dialog box toolbar, selects the “Configure” option from the drop-down menu, selects the “Set Instrument Channels” menu option, selects an instrument style from the list of sixteen musical instrument styles, selects the “Instrument” option, and finally selects an instrument style from a list one-hundred-twenty-eight instrument styles.

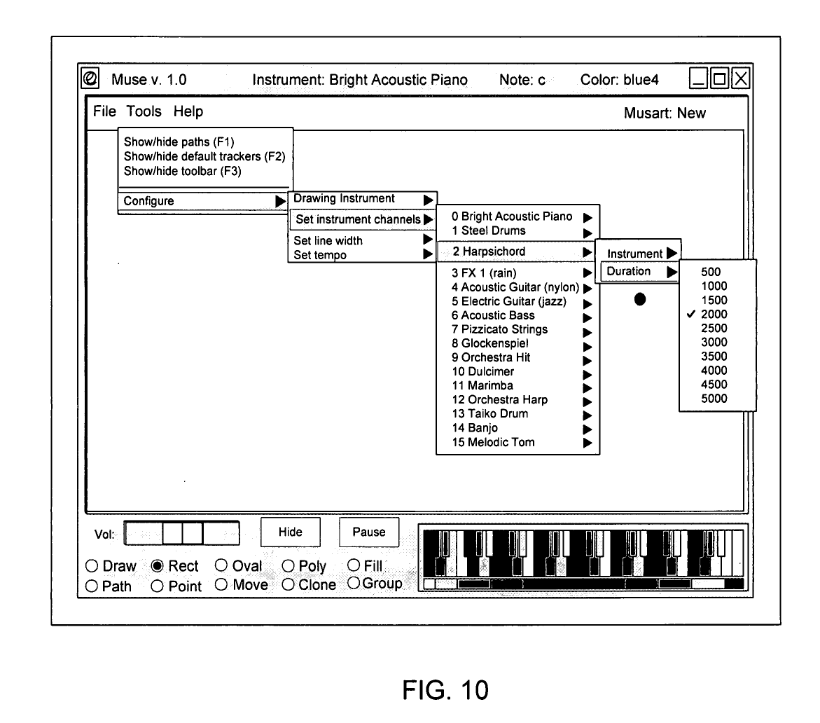

Additionally, as shown in FIG. 10, the user can also set a duration for each of the sixteen musical instruments by selecting the “Tools” button from the dialog box toolbar, selecting the “Configure” option from the drop-down menu, selecting the “Set Instrument Channels” menu option, selecting an instrument style from the list of sixteen musical instrument styles, selecting the “Duration” option, and finally selecting from a duration settings. Duration determines the length of time that a note is sounded once triggered. Other embodiments can allow changing durations automatically over time, based on the tone of a note sounded, the speed of the tracking object that caused the trigger, based on an external control or event, etc.

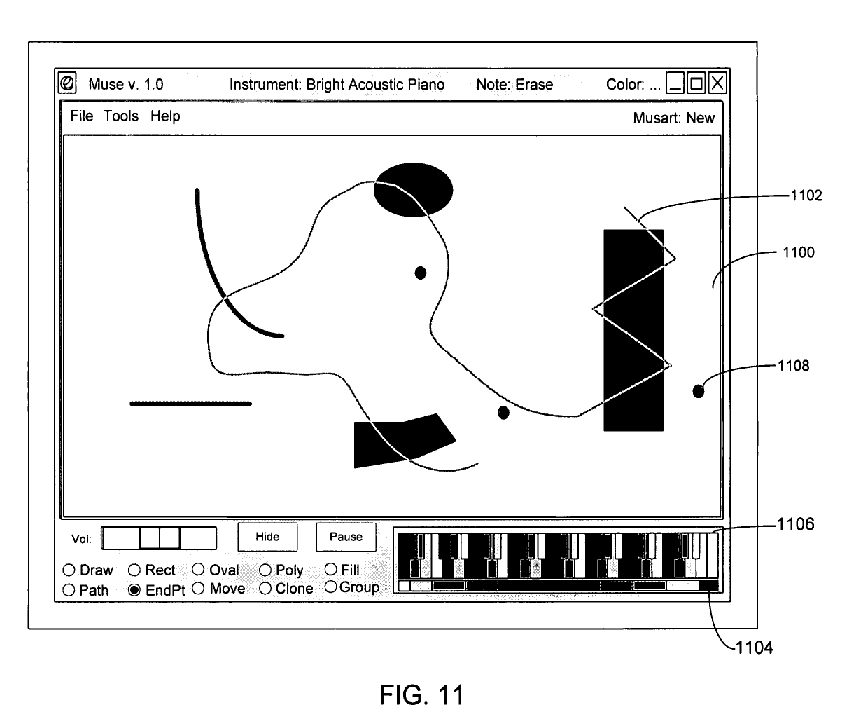

As shown in FIG. 11, another feature of a preferred embodiment allows a user to control a visual presentation of sound by disabling regions of the display screen canvas 5 so that tones are not sounded when tracking objects move within the disabled region of the display screen canvas 5. A region of the display screen canvas 5 is disabled by erasing a path 51 through the canvas 5. To erase the path 51 through the canvas 5, the user can select the rightmost chord key 53 (a key color-coded in black in the Muse 1.0 product) from the onscreen keyboard 9 and, by moving the mouse cursor on the canvas 5, drawing a path 51.

Another feature of a preferred embodiment allows a user to treat a mouse cursor like a tracking object so that when the mouse is moved on the display screen canvas and is in a predetermined relationship with a graphical object, a tone will sound as if the mouse cursor were a moving tracking object.

A further feature of a preferred embodiment allows a user to move graphical objects and tracking objects from the foreground of display screen canvas to the background of the display screen canvas and vice-versa. To move an object from the foreground to the background, the user can right-click on the object, this causes a popup menu to display, and select the “Raise” option. To move an object from the background to the foreground, the user right-clicks on the object and selects “Lower” from the popup menu.

A further feature of a preferred embodiment allows a user to control the overall volume of sound in a graphical presentation of sound or to control the volume at which an individual tone is sounded. To control the overall volume of sound, the user can adjust the volume by left-clicking the mouse on the slider bar, labeled “Vol:,” on the dialog box toolbar of FIG. 2 and dragging the slider bar to decrease or increase the volume. To control the volume for the sound of an individual tone, the user can right-click on a graphical object which causes a popup menu to display, select the “Object Volume” option to display a list a volume settings, and select a desired volume setting from the list. Alternatively, the user can right-click on a tracking object path which causes a popup menu to display, select the “Path Volume” option to display a list of volume settings, and select a desired volume setting from the list.

Another feature of a preferred embodiment allows a user to pause and restart a graphical presentation. This allows a user to stop the movement of tracking objects on the display screen canvas, stop tones from sounding, etc. and to resume movement and sound at a desired time. To pause the presentation, the user presses the “Pause” button at the bottom of the dialog box, the “Pause” button changes to a “Play” button. To restart the presentation, the user simply presses the “Play” button.

A further feature of the present invention allows a user to remove the tool bar from the Muse 1.0 dialog window. To remove the toolbar, the user can either select “Hide” button from the toolbar, press the “F3” function key on a PC keyboard, or select the “Tools” button on the toolbar and then select the “Show/Hide Toolbar (F3)” menu option. To make the toolbar visible, the user can press the “F3” function key again or select the “Tools” button on the toolbar and then select the “Show/Hide Toolbar (F3)” menu option.

### Saving and Linking Working Files

Once the user finalizes a visual presentation of sound, the user can save the presentation in a musical artwork file for playback at a later time. In a preferred embodiment, as shown in FIG. 2, the user saves the presentation by selecting the “File” button on the toolbar and selecting the “Save” menu option. Selecting the “Save” menu option causes a file-select dialog box to appear. After the user enters a filename and selects the “Save” button, a musical artwork file is created and saved with a “.mus” file extension. To open the musical artwork file, as shown in FIG. 2, the user selects the “Tools” button on the toolbar, selects the “File” button on the toolbar, selects the “Open” menu option, and selects then selects the musical artwork file to open.

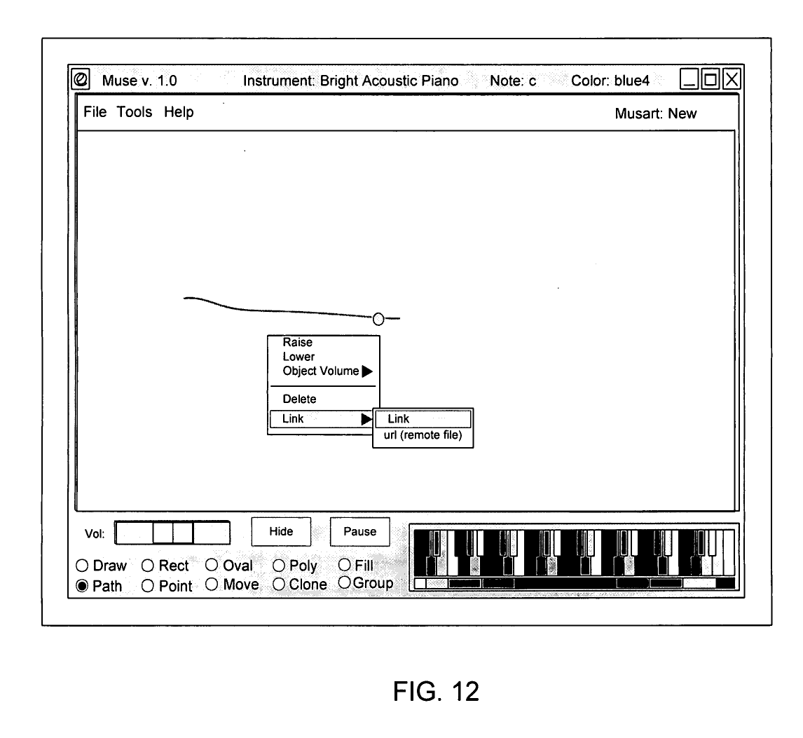

In FIG. 12, a preferred embodiment of the present invention also allows a user to link a musical artwork file to any object (graphical object, tracking object, etc.) of a presentation so that when a tracking object is in a predetermined relationship with the linked object, the musical artwork file is played. The musical artwork file can be a local file, a remote file located on a Web server anywhere on the Internet, etc. To add a musical artwork file link to an object, the user right-mouse clicks on the object which causes a cascading menu to display. By selecting the “local file” option on the cascading menu, a file-select dialog box is displayed that allows the user to load and link a local musical artwork file. By selecting the “url (remote file)” option, a user can load and link a remote musical artwork file.

### Playing the PC Keyboard

A preferred embodiment of the Muse 1.0 program provides an additional feature that allows a user to simulate playing a piano by playing music directly from a PC keyboard, or any other keyboard device etc. In this preferred embodiment, the keys from the top two rows of a PC keyboard are mapped to the keys of a piano as follows:

| PC KEY | NOTE | ALT-Chord |
|---|---|---|
| \grave{ } | C | Cmajor |
| (tab) | C# | |
| 1 | D | Dminor |
| q | D# | |
| 2 | E | Eminor |
| 3 | F | Fmajor |
| e | F# | |
| 4 | G | Gmajor |
| r | G# | |
| 5 | A | Aminor |
| t | A# | |
| 6 | B | B half dim 7 |
| 7 | C | C2major |
| u | C# | |
| 8 | D | Dmajor |
| i | D# | |
| 9 | E | Emajor |
| 0 | F | Fmaj7 |
| p | F# | |
| - | G | G7 |
| [ | G# | |
| = | A | Amajor |
| ] | A# | |
| (backspace) | B | Bmajor |
| \ | C | |

As an additional feature, holding the SHIFT key causes the PC keyboard keys numbered 7 and greater to increase by an octave, while causing the PC keyboard keys numbered 6 and less to drop octave.

### Description of the Hardware

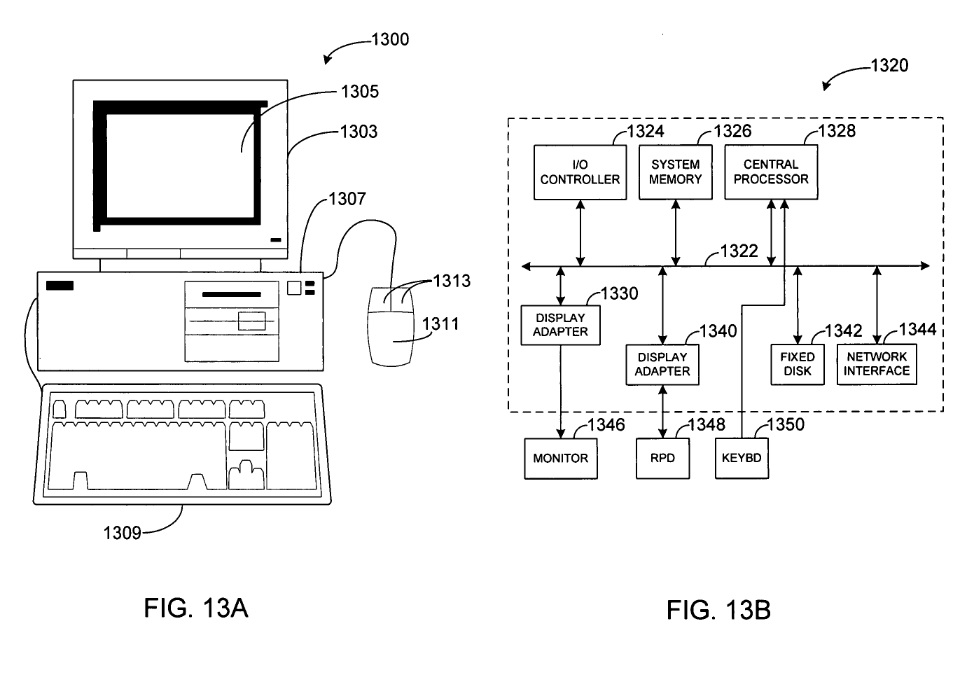

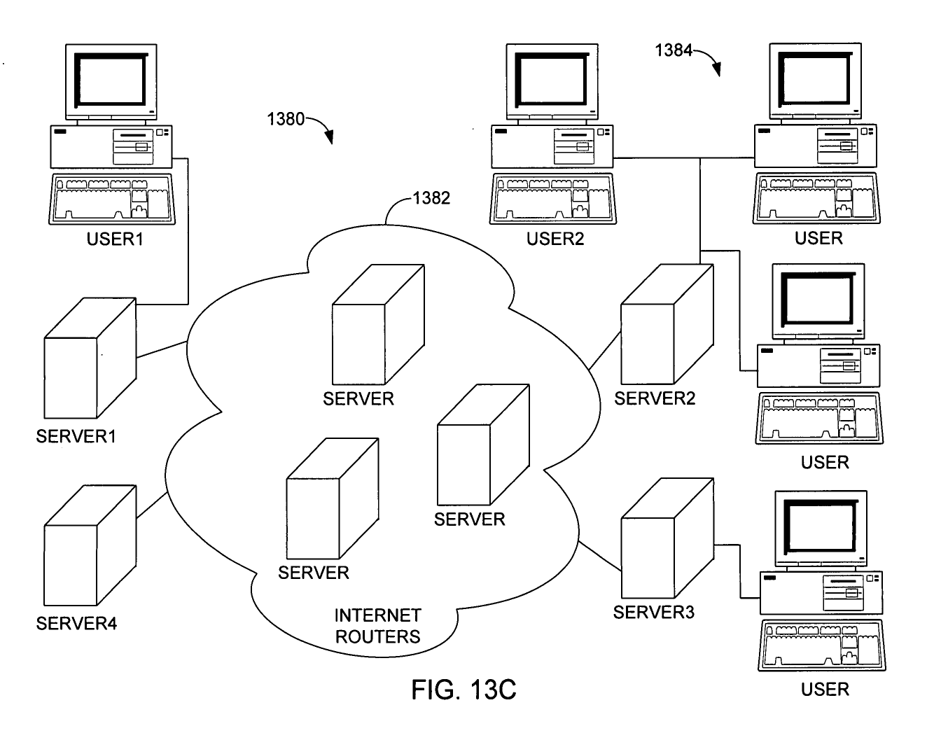

FIG. 13A is an illustration of a computer system 1 including a display 3 having a display screen 5. Cabinet 7 houses standard computer components (not shown) such as a disk drive, CDROM drive, display adapter, network card, random access memory (RAM), central processing unit (CPU), and other components, subsystems and devices. User input devices such as a mouse 11 having buttons 13, and a keyboard 9 are shown.

Other user input devices such a trackball, touch-screen, digitizing tablet, etc. can be used. In general, the computer system is illustrative of but one type of computer system, such as a desktop computer, suitable for use with the present invention. Computers can be configured with many different hardware components and can be made in many dimensions and styles (e.g. laptop, palmtop, pentop, server, workstation, mainframe). Any hardware platform suitable for performing the processing described herein is suitable for use with the present invention.

FIG. 13B illustrates subsystems that might typically be found in a computer such as computer 100.

In FIG. 13, subsystems within the box 20 are directly interfaced to an internal bus 22. Such subsystems typically are contained within the computer system such as within cabinet 7 of the FIG. 13A. Subsystems include input/output (I/O) controller 24, System Random Access Memory (RAM) 26, Central Processing Unit (CPU) 28, Display Adapter 30, Serial Port 40, Fixed Disk 42 and Network Interface Adapter 44. The use of bus 22 allows each of the subsystems to transfer data among the subsystems and, more importantly, with the CPU. External devices can communicate with the CPU or other subsystems via bus 22 by interfacing with a subsystem on the bus. Monitor 46 connects to the bus through Display Adapter 30. A relative pointing device (RPD) 48 such as a mouse connects through Serial Port 40. Some devices such Keyboard 50 can communicate with the CPU by direct means without using the main data bus as, for example, via an interrupt controller and associated registers (not shown).

As with the external physical configuration shown in FIG. 13A, many subsystem configurations are possible. FIG. 13B is illustrative of but one suitable configuration. Subsystems, components or devices other than those shown in FIG. 13B can be added. A suitable computer system can be achieved without using all of the subsystems shown in FIG. 2. For example, a standalone computer need not be coupled to a network so Network Interface 44 would no be required. Other subsystems such as a CDROM drive, graphics accelerator, etc. can be included in the configuration without affecting the performance of the system of the present invention.

FIG. 13C is a generalized diagram of a typical network.

In FIG. 13C, the network system 80 includes several local networks coupled to the Internet. Although specific network protocols, physical layers, topologies, and other network properties are presented herein, the present invention is suitable for use with any network.

In FIG. 13C, computer USER1 is connected to Server1. This connection can be by a network such as Ethernet, Asynchronous Transfer Mode, IEEE standard 1553 bus, modem connection, Universal Serial Bus, etc. The communication link need not be a wire but can be infrared, radio wave transmission, etc. Server1 is coupled to the Internet. The Internet is shown symbolically as a collection of sever routers 82. Note that the use of the Internet for distribution or communication of information is not strictly necessary to practice the present invention but is merely used to illustrate a preferred embodiment, below. Further the use of server computers and the designation of server and client machines is not crucial to an implementation of the present invention. USER1 Computer can be connected directly to the Internet. Server1's connection to the Internet is typically by a relatively high bandwidth transmission medium such as a T1 or T3 line.

Similarly, other computers at 84 are shown utilizing a local network at a different location from USER1 computer. The computers at 84 are coupled to the Internet via Server2. USER3 and Server3 represent yet a third installation.

Note that the concepts of “client” and “server,” as used in this application and the industry are very loosely defined and, in fact, are not fixed with respect to machines or software processes executing on the machines. Typically, a server is a machine or process that is providing information to another machine or process, i.e., the “client,” that requests the information. In this respect, a computer process can be acting as a client at one point in time (because it is requesting information) and can be acting as a server at another point in time (because it is providing information). Some computers are consistently referred to as “severs' because they usually act as a repository for a large amount of information that is often requested. For example, a Word Wide Web (WWW, or simply, “Web”) site is often hosted by a server computer with a large storage capacity, high-speed processor and Internet link having the ability to handle many high-bandwidth communication lines.

A server machine will most likely not be manually operated by a human user on a continual basis, but, instead, has software for constantly, and automatically, responding to information requests. On the other hand, some machines, such desktop computers, are typically thought of as client machines because they are primarily used to obtain information from the Internet for a user operating the machine.

Depending on the specific software executing at any point in time on these machines, the machine may actually be performing the role of a client or server, as the need may be. For example, a user's desktop computer can provide information to another desktop computer. Or a server may directly communicate with another server computer. Sometimes this is characterized as “peer-to-peer,” communication. Although processes of the present invention, and the hardware executing the processes, may be characterized by language common to a discussion at the Internet (e.g. “client,” server,” “peer”) it should be apparent that software of the present invention can execute on any type of suitable hardware including networks other than the Internet.

Although software of the present invention may be presented as a single entity, such software is readily able to be executed on multiple machines. That is, there may be multiple instances of a given software program, a single program may be executing on two or more processors in a distributed processing environment, parts of a single program may be executing on different physical machines, etc. Further, two different programs, such as a client and sever program, can be executing in a single machine, or in different machines. A single program can be operating as a client for one information transaction and as a server for a different information transaction.

Table I, below, shows a list of source code files provided on a CD-ROM as a Source Code Appendix for this application. The files are on one CD-ROM. Two identical copies of the CD-ROM are provided. The files were recorded using an International Business Machines (IBM) compatible personal computer running Microsoft™ Windows XP™ operating system and can be viewed with compatible equipment. All files are ASCII format. File extensions include .inf, .tcl, .mus, .tkd.

TABLE 1

| | |
|---|---|
| Directory of D:\ | |
| 09/18/2005 04:01 PM | 19,300 Freight-Train2.mus |
| 07/22/2005 07:56 AM | 4,832 autoscroll.tcl |
| 08/02/2005 12:56 AM | 1,113 blank.mus |

| | | |
|---|---|---|
| 05/23/2006 07:40 PM | <DIR> | lib |

| | |
|---|---|
| 09/18/2005 04:03 PM | 200 main.tcl |
| 09/23/2005 02:06 AM | 138,927 muse.tcl |
| 07/22/2005 07:56 AM | 79 pkgIndex.tcl |

| | | |
|---|---|---|
| 05/23/2006 07:40 PM | <DIR> | sounds |

| | |
|---|---|
| 09/23/2005 01:47 AM | 170 tclkit.inf |
| 09/18/2005 08:16 PM | 122,443 wikit.tkd |

| | |
|---|---|
| 8 File(s) | 287,064 bytes |

| | | |
|---|---|---|
| Directory of D:\lib | | |
| 05/23/2006 07:40 PM | <DIR> | . |
| 05/23/2006 07:40 PM | <DIR> | .. |

| | |
|---|---|
| 07/22/2005 07:54 AM | 158 Darwin critcl.tcl |
| 07/22/2005 07:54 AM | 157 Linux critcl.tcl |
| 07/22/2005 05:36 PM | 682 Style pkgIndex.tcl |
| 07/22/2005 07:54 AM | 159 Windows critcl.tcl |
| 07/22/2005 05:36 PM | 4,497 as.tcl |
| 07/22/2005 07:54 AM | 1,667 critcl.tcl |
| 08/24/2005 11:40 AM | 17,996 fetchurl.tcl |
| 07/22/2005 05:36 PM | 2,374 lobster.tcl |
| 08/05/2005 01:51 AM | 8,288 music.tcl |
| 07/22/2005 07:54 AM | 66 pkgIndex.tcl |
| 07/22/2005 05:36 PM | 668 style.tcl |
| 06/15/2005 03:30 AM | 954 tbcload pkgIndex.tcl |

| | | |
|---|---|---|
| 05/23/2006 07:40 PM | <DIR> | tile |
| 05/23/2006 07:40 PM | <DIR> | wikit |

| | |
|---|---|
| 12 File(s) | 37,666 bytes |

| | | |
|---|---|---|
| Directory of D:\lib\tile | | |
| 05/23/2006 07:40 PM | <DIR> | . |
| 05/23/2006 07:40 PM | <DIR> | .. |

| | |
|---|---|
| 08/05/2005 06:54 AM | 2,529 altTheme.tcl |
| 08/05/2005 06:54 AM | 1,936 aquaTheme.tcl |
| 08/05/2005 06:54 AM | 2,959 button.tcl |
| 08/05/2005 06:54 AM | 3,497 clamTheme.tcl |
| 08/05/2005 06:54 AM | 2,813 classicTheme.tcl |
| 08/05/2005 06:54 AM | 9,364 combobox.tcl |
| 08/05/2005 06:54 AM | 376 cursors.tcl |
| 08/05/2005 06:54 AM | 2,836 defaults.tcl |
| 08/05/2005 06:54 AM | 7,044 dialog.tcl |
| 08/05/2005 06:54 AM | 16,932 entry.tcl |
| 08/05/2005 06:54 AM | 4,305 fonts.tcl |
| 08/05/2005 06:54 AM | 2,433 icons.tcl |
| 08/05/2005 06:54 AM | 5,243 keynav.tcl |
| 08/05/2005 06:54 AM | 4,913 menubutton.tcl |
| 08/05/2005 06:54 AM | 3,070 notebook.tcl |
| 08/05/2005 06:54 AM | 2,089 paned.tcl |
| 08/05/2005 06:54 AM | 736 pkgIndex.tcl |
| 08/05/2005 06:54 AM | 1,085 progress.tcl |
| 08/05/2005 06:54 AM | 1,175 scale.tcl |
| 08/05/2005 06:54 AM | 2,701 scrollbar.tcl |
| 08/05/2005 06:54 AM | 2,113 stepTheme.tcl |
| 08/05/2005 06:54 AM | 9,573 tile.tcl |
| 08/05/2005 06:54 AM | 8,355 treeview.tcl |
| 08/05/2005 06:54 AM | 1,756 winTheme.tcl |
| 08/05/2005 06:54 AM | 1,133 xpTheme.tcl |

| | |
|---|---|
| 25 File(s) | 100,966 bytes |

| Directory of D:\lib\wikit | | |
|---|---|---|
| 05/23/2006 07:40 PM | <DIR> | . |
| 05/23/2006 07:40 PM | <DIR> | .. |

| | |
|---|---|
| 07/22/2005 07:56 AM | 28,506 format.tcl |
| 08/08/2005 10:51 PM | 18,242 gui.tcl |
| 07/22/2005 07:56 AM | 5,888 modify.tcl |
| 07/22/2005 07:56 AM | 470 pkgIndex.tcl |
| 07/22/2005 07:56 AM | 12,971 utils.tcl |
| 07/22/2005 07:56 AM | 11,644 web.tcl |
| 07/22/2005 07:56 AM | 716 wikit.tcl |

| | |
|---|---|
| 7 File(s) | 78,437 bytes |

| | | |
|---|---|---|
| Directory of D:\sounds | | |
| 05/23/2006 07:40 PM | <DIR> | . |
| 05/23/2006 07:40 PM | <DIR> | .. |

| | |
|---|---|
| 07/22/2005 03:16 AM | 93,084 muse.sf2 |

| | |
|---|---|
| 1 File(s) | 93,084 bytes |

| | |
|---|---|
| Total Files Listed: | |
| 53 File(s) | 597,217 bytes |
| 12 Dir(s) | 0 bytes free |

Although the invention has been described with respect to particular embodiments thereof, these embodiments are merely illustrative and not restrictive of the invention. For example, although the invention has been presented in connection with specific database applications it should be apparent that any conceivable database application can benefit from features of the present invention.

A “term” or “search term” can include any condition, operator, symbol, name, phrase, keyword, meta-character (e.g., a “wild card” character), function call, utility, database language construct or other mechanism used to facilitate a search of data. It should be apparent that many traditional techniques used in database query and results presentation can be used to advantage with features of the present invention. Search terms need not be limited to a single text input but can include multiple lines of functional text or other information.

In some embodiments not all of the steps discussed herein need be used. Many such variations will be apparent to one of skill in the art.

Note that although specific means of user input and output are presented, any suitable input or output devices or approaches can be suitable for use with the present invention. For example, any number and type of text boxes, menus, selection buttons, or other controls can be used in any arrangement produced by any suitable display device. User input devices can include a keyboard, mouse, trackball, touchpad, data glove, etc. Display devices can include electronic displays, printed or other hardcopy or physical output, etc. Although the user interfaces of the present invention have been presented primarily as web pages, any other format, design or approach can be used. User input and output can also include other forms such as three-dimensional representations and/or audio. For example, voice recognition and voice synthesis can be used. In general, any input or output device can be employed.

Any suitable programming language can be used to implement the routines of the present invention including C, C++, Java, assembly language, etc. Different programming techniques can be employed such as procedural or object oriented. The routines can execute on a single processing device or multiple processors. The functions of the invention can be implemented in routines that operate in any operating system environment, as standalone processes, in firmware, dedicated circuitry or as a combination of these or any other types of processing.

Steps can be performed in hardware or software, as desired. Note that steps can be added to, taken from or modified from the steps presented in this specification or Figures without deviating from the scope of the invention. In general, descriptions of functional steps, such as in tables or flowcharts are only used to indicate one possible sequence of basic operations to achieve a functional aspect of the present invention. Functioning embodiments of the invention may be realized with more or less processing than is described herein.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, personal digital assistant (PDA), cell phone or other hand-held processor, or any of the like. A “computer program” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” or “machine-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. Although the invention is described with respect to a client-server network organization, any network topology or interconnection scheme can be used. For example, peer-to-peer communications can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Any communication channel or connection can be used such as wired, wireless, optical, etc.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms discussed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

The scope of the invention is to be determined solely by the appended claims.

What is claimed is:

1. A method for creating a graphical presentation of sound, the method executing in a system including a display screen, a processor and a user input device, the method comprising:
receiving a first signal from the user input device to specify a tone;
receiving a second signal from the user input device;
displaying, in response to the second signal, a graphical object on a canvas of the display screen;
receiving a third signal from the user input device;
defining a path in response to the third signal;
moving a tracking object on the canvas along the path; and
sounding the tone when the tracking object is in a predetermined relationship with the graphical object.

2. The method of claim 1, wherein the tone is a note.

3. The method of claim 1, wherein the tone is a chord.

4. The method of claim 1, wherein the tone includes a sound associated with a musical instrument.

5. The method of claim 4, further comprising:
receiving a fourth signal from the user input device;
selecting a second musical instrument in response to the fourth signal; and
sounding the tone by playing a sound associated with the second musical instrument.

6. The method of claim 1, further comprising accepting a signal from the user input device to modify the tone.

7. The method of claim 1, wherein displaying the graphical object on the canvas of the display screen further comprises:
selecting a color, wherein the graphical object is displayed in the color.

8. The method of claim 7, further comprising:
accepting a signal from the user input device to modify the color.

9. The method of claim 1, wherein displaying the graphical object on the canvas of the display screen further comprises:
displaying the graphical object as one of the following: line, rectangle, oval, polygon, triangle, or circle.

10. The method of claim 1, wherein displaying the graphical object on the canvas of the display screen further comprises:
displaying the graphical object as a visual image.

11. The method of claim 1, wherein displaying the graphical object on the canvas of the display screen further comprises:
displaying the graphical object as a photographic image.

12. The method of claim 1, wherein displaying the graphical object on the canvas of the display screen further comprises:
displaying the graphical object as a video image.

13. The method of claim 1, further comprising accepting a signal from the user input device to modify the graphical object.

14. The method of claim 1, further comprising:
accepting a signal from the user input device to delete the graphical object.

15. The method of claim 1, further comprising:
accepting a signal from the user input device to move the graphical object on the canvas of the display screen.

16. The method of claim 1, further comprising:
accepting a signal from the user input device to duplicate the graphical object.

17. The method of claim 1, further comprising:
selecting a speed and moving the tracking object along the path at the speed.

18. The method of claim 17, further comprising:
selecting a tempo; and
moving the tracking object along the path at the tempo.

19. The method of claim 1, further comprising:
using a cursor as the tracking object.

20. The method of claim 19, wherein the cursor is controlled by the user input device.

21. The method of claim 1, further comprising:
disabling a region of the canvas to prevent sounding the tone when the tracking object is in a predetermined relationship with the graphical object.

22. The method of claim 1, further comprising:
saving the graphical presentation of sound to a file.

23. The method of claim 1, further comprising:
linking the a presentation of sound to the graphical object to play the presentation of sound when the tracking object is in a predetermined relationship with the graphical object.

24. The method of claim 1, further comprising:
linking a graphical presentation of sound to the tracking object to play the presentation of sound when the tracking object is in a predetermined relationship with the graphical object.

25. An apparatus for creating a graphical presentation of sound, the apparatus comprising:
a display screen having a canvas;
a processor coupled to the display screen and a user input device, wherein the user input device controls a cursor on the canvas;
a machine-readable medium including instructions for execution by the processor, the machine-readable medium including:
one or more instructions for receiving a first signal from the user input device to specify a tone;
one or more instructions for receiving a second signal from the user input device to display a graphical object on the canvas;
one or more instructions for receiving a third signal from the user input device;
one or more instructions for defining a path in response to the third signal;
one or more instructions for moving a tracking object on the canvas along the path; and
one or more instructions for sounding the tone when the tracking object is in a predetermined relationship with the graphical object.

26. A machine-readable medium including instructions executable by a processor for creating a graphical presentation of sound, the machine-readable medium comprising:
one or more instructions for receiving a first signal from a user input device to specify a tone;
one or more instructions for receiving a second signal from the user input device to display, in response to the second signal, a graphical object on a canvas of a display screen;
one or more instructions for receiving a third signal from the user input device;
one or more instructions for defining a path in response to the third signal;
one or more instructions for moving a tracking object on the canvas along the path; and
one or more instructions for sounding the tone when the tracking object is in a predetermined relationship with the graphical object.

27. A method for playing a graphical presentation of sound, the method executing in a system including a display screen, a processor and a user input device, the method comprising:
receiving a first signal from the user input device;
displaying, in response to the first signal, an object on a canvas of a display screen;
moving a tracking object on the canvas;
receiving a second signal from the user input device to select a file, wherein the file includes the graphical presentation of sound;
linking the file to the object; and
playing the graphical presentation of sound when the tracking object is in a predetermined relationship with the object.

28. The method of claim 27, wherein the file includes a local file.

29. The method of claim 27, wherein the file includes a remote file.
